(19) United States
(12) Patent Application Publication
(10) Pub. No.: US 2026/0194730 A1
(43) Pub. Date: Jul. 9, 2026

(54) IMAGING LENS AND IMAGING DEVICE

(71) Applicant: Tamron Co., Ltd., Saitama (JP)

(72) Inventor: Keisuke TAKADA, Saitama (JP)

(73) Assignee: Tamron Co., Ltd., Saitama (JP)

(21) Appl. No.: 19/360,625

(22) Filed: Oct. 16, 2025

(30) Foreign Application Priority Data
Dec. 26, 2024 (JP) 2024-230424

(51) Int. Cl. G02B 9/34; G02B 13/00

(52) U.S. Cl. CPC G02B 9/34; G02B 13/006

(57) ABSTRACT

An imaging lens included in an imaging device includes a negative first lens, a positive second lens having a meniscus shape, an aperture stop, a positive third lens, and a positive cemented lens composed of a positive fourth lens and a negative fifth lens, and satisfies a specific formula relating to the fourth and fifth lenses.

### CROSS-REFERENCE TO RELATED APPLICATIONS

This application is based on and claims the benefit of priority from Japanese Patent Application No. 2024-230424, filed on Dec. 26, 2024, the entire contents of which are incorporated herein by reference.

### BACKGROUND OF THE INVENTION

### Technical Field

The present invention relates to an imaging lens and an imaging device.

### Related Art

Imaging devices, such as single-lens reflex cameras, mirrorless interchangeable-lens cameras, and digital still cameras, which are portable imaging devices, and surveillance imaging devices and in-vehicle imaging devices, which are installed and fixed-type imaging devices, have long been widely used. Solid-state imaging elements such as charge coupled device (CCD) sensors or complementary metal oxide semiconductor (CMOS) sensors are used in these imaging devices. In the imaging lenses used in such imaging devices, higher performance is required as the number of pixels in solid-state imaging elements increases.

In recent years, systems referred to as advanced driver assistance system (ADAS), which perform sensing using in-vehicle imaging devices and provide appropriate driving assistance based on analysis of images obtained from the imaging devices, have begun to gain widespread use. With respect to imaging lenses constituting in-vehicle imaging devices, there is a demand for compact and low-cost lenses that are capable of capturing high-resolution images while exhibiting minimal performance variation due to decentering sensitivity.

For such imaging lenses, an optical system is known that includes, in order from an object side to an image plane side, a negative lens having a concave shape facing the image plane side, a positive lens, a biconvex lens, and a cemented lens having positive combined power (see, for example, JP 2009-75141 A). For such imaging lenses, an optical system is also known that includes, in order from the object side to the image plane side, a negative lens having a concave shape facing the image plane side, a positive lens, a biconvex lens, a negative lens, and a positive lens (see, for example, JP 2020-38401 A).

In recent years, in order to support high resolution, bright optical systems with large aperture ratios have been in demand. When considering the application of such optical systems to in-vehicle sensing imaging devices, brighter imaging lenses are required.

However, in the optical system disclosed in JP 2009-75141 A, an F-number of the optical system is approximately 2.0, and it may be unattainable to ensure sufficient brightness. Moreover, in the optical system disclosed in JP 2009-75141 A, when attempting to increase the aperture ratio, it becomes difficult to ensure optical performance due to inappropriate power arrangement of individual lenses. Furthermore, in the optical system disclosed in JP 2020-38401 A, the power configuration of the lenses near the image plane is positive-negative-positive, and thus, the decentering sensitivity of each lens is high, making lens alignment adjustments difficult and resulting in difficulty in ensuring stable optical performance. Thus, there remains room for improvement in the prior art from the viewpoint of achieving an imaging lens that is compact, bright, and has stable optical performance.

An object of one aspect of the present invention is to provide an imaging lens and an imaging device that are compact, bright, and have stable optical performance.

### SUMMARY OF THE INVENTION

In order to solve the above-described problems, an imaging lens according to one aspect of the present invention includes, in order from an object side toward an image plane side: a first lens having negative refractive power; a second lens having positive refractive power and a meniscus shape; an aperture stop; a third lens having positive refractive power; and a cemented lens composed of a fourth lens having positive refractive power and a fifth lens having negative refractive power, the cemented lens having positive combined refractive power, the imaging lens satisfying the following formula:

$$20. \leq f\_L45 / f \leq 110. \qquad ( 1 )$$

here,
f_L45 is the focal length of the cemented lens, and
f is the focal length of the imaging lens.

In order to solve the above-described problems, an imaging device according to one aspect of the present invention includes: the above-described imaging lens; and an imaging element that is disposed on an image plane side of the imaging lens and converts an optical image formed by the imaging lens into an electrical signal.

### Effect of the Invention

According to one aspect of the present invention, it is possible to provide an imaging lens and an imaging device that are compact, bright, and have stable optical performance.

### BRIEF DESCRIPTION OF THE DRAWINGS

FIG. 1 is a diagram schematically illustrating a lens configuration of an imaging lens according to Example 1;

FIG. 2 is a diagram illustrating a longitudinal aberration of the imaging lens according to Example 1;

FIG. 3 is a diagram schematically illustrating a lens configuration of an imaging lens according to Example 2;

FIG. 4 is a diagram illustrating a longitudinal aberration of the imaging lens according to Example 2;

FIG. 5 is a diagram schematically illustrating a lens configuration of an imaging lens according to Example 3;

FIG. 6 is a diagram illustrating a longitudinal aberration of the imaging lens according to Example 3;

FIG. 7 is a diagram schematically illustrating a lens configuration of an imaging lens according to Example 4;

FIG. 8 is a diagram illustrating a longitudinal aberration of the imaging lens according to Example 4;

FIG. 9 is a diagram schematically illustrating a lens configuration of an imaging lens according to Example 5;

FIG. 10 is a diagram illustrating a longitudinal aberration of the imaging lens according to Example 5;

FIG. 11 is a diagram schematically illustrating a lens configuration of an imaging lens according to Example 6;

FIG. 12 is a diagram illustrating a longitudinal aberration of the imaging lens according to Example 6; and

FIG. 13 is a diagram schematically illustrating a configuration of an imaging device according to one embodiment of the present invention.

### DESCRIPTION OF THE EMBODIMENTS

In the following description, the term “lens” excludes parallel flat plates and may refer to single lens. Examples of single lens include biconvex lens, plano-convex lens, convex meniscus lens, and concave meniscus lens. The lens may be a spherical lens or an aspherical lens. An aspherical lens refers to a lens in which at least one lens surface is aspherical. Examples of aspherical lens include: composite lens having a resin layer with an aspherical shape on at least one lens surface, and glass-molded aspherical lens which is made of glass material and in which at least one lens surface has an aspherical shape. The term “cemented lens” refers to a structure in which two or more single lenses are integrated without an air gap.

In the following description, the term “refractive power” is also referred to as “power”. A lens having positive refractive power is referred to as “positive lens”, and a lens having negative refractive power is referred to as “negative lens”.

### [Imaging Lens]

An imaging lens according to one embodiment of the present invention may have a configuration including, in order from an object side toward an image plane side: a first lens having negative power; a second lens having positive power and a meniscus shape; an aperture stop; a third lens having positive power; and a cemented lens composed of a positive fourth lens and a negative fifth lens, the cemented lens having positive combined power. In an application such as in-vehicle camera, this configuration is preferable from the viewpoint of achieving downsizing of the camera and high-quality imaging performance. It is preferable, from the above viewpoint, that the imaging lens includes only the above-described first to fifth lenses as its constituent lenses.

[Optical configuration]

### <First Lens>

The first lens has negative refractive power. The first lens may be appropriately selected from known negative lenses.

### <Second Lens>

The second lens has a meniscus shape and has positive refractive power. The second lens may be appropriately selected from known positive meniscus lenses.

It is preferable that the second lens is a positive meniscus lens having a convex surface facing the image plane side. By adopting such a positive meniscus lens as the second lens, the position of the principal point of the second lens can be located on the image plane side (rear side) of the second lens. Therefore, the above configuration is preferable from the viewpoint of securing space on the image plane side (rear side) of the second lens.

### <Third Lens>

The third lens has positive refractive power. The third lens may be appropriately selected from known positive lenses.

### <Cemented Lens>

The imaging lens of the present embodiment includes the cemented lens composed of the fourth lens having positive refractive power and the fifth lens having negative refractive power, the cemented lens having positive combined refractive power. It is preferable to have such a cemented lens from the viewpoint of favorably correcting aberrations generated by the first and second lenses. Furthermore, in order to reduce the overall length of the imaging lens, it is desirable to reduce the number of lenses, and it is also preferable from the viewpoint of downsizing the imaging lens to have this cemented lens. Thus, it is preferable to include such a cemented lens particularly from the viewpoint of maintaining favorable correction of spherical aberration and chromatic aberration even under strict constraints on diameter and overall length, and from the viewpoint of achieving an imaging lens with favorable aberration performance.

The fourth lens has positive refractive power. The positive refractive power of the fourth lens may be appropriately determined within a range in which the cemented lens, when composed by combining the fourth lens with the fifth lens, has positive combined refractive power. The fourth lens may be appropriately selected from known positive lenses within the range in which the fourth lens can be combined with the fifth lens to form the cemented lens.

The fifth lens has negative refractive power. The negative refractive power of the fifth lens may be appropriately determined within a range in which the cemented lens, when composed by combining the fifth lens with the fourth lens, has positive combined refractive power. The fifth lens may be appropriately selected from known negative lenses within the range in which the fifth lens can be combined with the fourth lens to form the cemented lens.

### <Aperture Stop>

The aperture stop is disposed between the second lens and the third lens. The position of the aperture stop may be anywhere in the optical path between the second lens and the third lens, and sufficient brightness and sufficient optical performance of the imaging lens can be achieved at any such position. The position of the aperture stop may be determined, for example, according to the configuration of a lens barrel in which the imaging lens is housed.

### <Other Optical Elements>

The imaging lens of the present embodiment may include, in addition to the lenses and aperture stop described above, optical elements other than lenses as additional optical elements, within a range in which the effects of the present invention can be obtained. Examples of such additional optical elements include optical filters, face plates, quartz low-pass filters, and infrared cut filters. For example, it is preferable for the imaging lens to include the above-described filters between a final lens and the image plane from the viewpoint of reducing the overall lens diameter.

It is preferable that the space between the second lens and the third lens is an air gap from the viewpoint of obtaining optical effects from the second and third lenses. However, optical elements other than lenses, such as the above-described additional optical elements, may be interposed between the second lens and the third lens.

### [Optical Characteristics]

It is preferable that the imaging lens of the present embodiment satisfies at least one of the formulae described below, from the viewpoint of achieving an imaging lens that is compact, bright, and has stable optical performance.

$$< Formula ( 1 ) >$$

$$20. \leq f\_L45 / f \leq 110. \qquad ( 1 )$$

here,
f_L45 is the focal length of the cemented lens, and
f is the focal length of the imaging lens.

Formula (1) relates to the positive power of the cemented lens composed of the positive fourth lens and the negative fifth lens having combined power. When f_L45/f exceeds 110.00, the positive power of the cemented lens becomes excessively weak, resulting in increased astigmatism and coma, making aberration correction in the overall imaging lens difficult. Furthermore, the lens diameter tends to become larger, making downsizing of the imaging lens difficult. When f_L45/f is less than 20.00, the positive power of the cemented lens becomes excessively strong, increasing decentering sensitivity and making it difficult to adjust the alignment of the individual lenses in the imaging lens, thereby making it difficult to ensure favorable optical performance.

From the viewpoint of favorable correction of aberrations and radial downsizing, it is more preferable that f_L45/f is 105.00 or less, and even more preferable that f_L45/f is 100.00 or less. From the viewpoint of suppressing variations in optical characteristics due to variations in decentering sensitivity, it is more preferable that f_L45/f is 21.00 or more.

$$< Formula ( 2 ) >$$

$$- 0.12 \leq f\_L1 / f\_L45 \leq - 0.01 \qquad ( 2 )$$

here,
f_L1 is the focal length of the first lens, and
f_L45 is the focal length of the cemented lens.

Formula (2) relates to an appropriate ratio of the refractive power of the first lens to the refractive power of the cemented lens. It is preferable for the imaging lens to satisfy Formula (2) from the viewpoint of achieving both favorable correction of various aberrations and downsizing of the imaging lens. When f_L1/f_L45 is less than −0.120, the amount of aberration generated by the fourth and fifth lenses becomes large, which may worsen astigmatism, coma, and lateral chromatic aberration. When f_L1/f_L45 exceeds −0.010, the amount of aberration generated by the first lens becomes large, which may worsen coma.

From the viewpoint of favorable correction of aberrations, it is more preferable that f_L1/f_L45 is −0.090 or more, and even more preferable that f_L1/f_L45 is −0.080 or more. Additionally, from the viewpoint of favorable correction of coma, it is more preferable that f_L1/f_L45 is −0.015 or less.

$$< Formula ( 3 ) >$$

$$0.18 \leq f\_L3 / f\_L2 \leq 0.6 \qquad ( 3 )$$

here,
f_L2 is the focal length of the second lens, and
f_L3 is the focal length of the third lens.

Formula (3) relates to the ratio of the focal length of the second lens to the focal length of the third lens. When f_L3/f_L2 is less than 0.180, error sensitivity due to decentering relative to the optical axis of the third lens tends to increase. When f_L3/f_L2 exceeds 0.600, coma and astigmatism are likely to occur or increase.

From the viewpoint of suppressing variations in optical characteristics caused by variations in decentering sensitivity, it is more preferable that f_L3/f_L2 is 0.200 or more, and even more preferable that f_L3/f_L2 is 0.250 or more. From the viewpoint of suppressing the generation of aberrations, it is more preferable that f_L3/f_L2 is 0.550 or less, and even more preferable that f_L3/f_L2 is 0.450 or less.

$$< Formula ( 4 ) >$$

$$4. \leq f\_L2 / f \leq 10. \qquad ( 4 )$$

here,
f_L2 is the focal length of the second lens, and
f is the focal length of the imaging lens.

Formula (4) relates to an appropriate ratio of the positive refractive power of the second lens to the refractive power of the imaging lens. It is preferable for the imaging lens to satisfy Formula (4) from the viewpoint of achieving both favorable correction of various aberrations and downsizing of the imaging lens. When f_L2/f is less than 4.00, the positive refractive power of the second lens becomes excessively strong, which may result in the generation of coma and astigmatism. When f_L2/f exceeds 10.00, the positive refractive power of the second lens becomes excessively weak, making it difficult to shorten the overall length of the imaging lens.

From the viewpoint of suppressing the generation of aberrations, it is more preferable that f_L2/f is 4.50 or more, and even more preferable that f_L2/f is 5.00 or more. From the viewpoint of axial downsizing of the imaging lens, it is more preferable that f_L2/f is 9.50 or less, and even more preferable that f_L2/f is 8.50 or less.

$$< Formula ( 5 ) >$$

$$- 1. \leq f\_L1 / f\_L3 \leq - 0.3 \qquad ( 5 )$$

here,
f_L1 is the focal length of the first lens, and
f_L3 is the focal length of the third lens.

Formula (5) relates to the ratio of the focal length of the first lens to the focal length of the third lens. When f_L1/f_L3 is less than −1.00, the image plane tilts toward an under-focus side, which may result in an image in which focus is not achieved uniformly between the central portion and the peripheral portion of the screen. When f_L1/f_L3 exceeds −0.30, the image plane tilts toward an over-focus side, which may similarly result in an image in which focus is not achieved uniformly between the central portion and the peripheral portion of the screen.

From the viewpoint of suppressing the tilt of the image plane toward the under-focus side, it is more preferable that f_L1/f_L3 is −0.95 or more, and even more preferable that f_L1/f_L3 is −0.85 or more. From the viewpoint of suppressing the tilt of the image plane toward the over-focus side, it is more preferable that f_L1/f_L3 is −0.40 or less, and even more preferable that f_L1/f_L3 is −0.50 or less.

$$< Formula ( 6 ) >$$

$$0.01 \leq f\_L3 / f\_L45 \leq 0.15 \qquad ( 6 )$$

here,
f_L3 is the focal length of the third lens, and
f_L45 is the focal length of the cemented lens.

Formula (6) relates to the ratio of the focal length of the third lens to the combined focal length of the cemented lens composed of the fourth lens and the fifth lens. It is preferable for the third lens to have positive refractive power that mainly contributes to imaging. Therefore, for the third lens and the cemented lens, it is preferable to set the focal length ratio so that spherical aberration and coma can be favorably corrected, while also considering axial downsizing of the imaging lens or securing a back focus.

When f_L3/f_L45 is less than 0.010, the back focus of the imaging lens may become excessively short, making assembly impossible or resulting in insufficient correction of spherical aberration caused by the third lens. When f_L3/f_L45 exceeds 0.150, the overall length of the imaging lens may become excessively long, or coma generated by the cemented lens may not be sufficiently corrected.

From the viewpoint of ensuring assemblability and the viewpoint of favorable correction of aberrations, it is more preferable that f_L3/f_L45 is 0.012 or more, and even more preferable that f_L3/f_L45 is 0.015 or more. Also, from the viewpoint of axial downsizing of the imaging lens and the viewpoint of favorably correcting spherical aberration, it is more preferable that f_L3/f_L45 is 0.012 or more, and even more preferable that f_L3/f_L45 is 0.015 or more. It is more preferable that f_L3/f_L45 is 0.125 or less, and even more preferable that f_L3/f_L45 is 0.098 or less.

$$< Formula ( 7 ) >$$

$$- 3. < G 45 L 1 SF < - 1.20 \qquad ( 7 )$$

Formula (7) relates to the shape (shaping factor) of the cemented lens. In Formula (7), “G45L1SF” is expressed by the following Formula (7-1).

G45L1SF=(G4L1Lr+G5L1Rr)/(G4L1Lr−G5L1Rr) (7-1)

In Formula (7-1), “G4L1Lr” is the radius of curvature of the object side lens surface of the fourth lens, and “G5L1Rr” is the radius of curvature of the image plane side lens surface of the fifth lens. It is preferable for the imaging lens to satisfy Formula (7) from the viewpoint of favorably correcting lateral chromatic aberration and coma.

When G45L1SF is −3.00 or less, the radius of curvature of the fourth lens becomes excessively large, resulting in insufficient refractive power, which may cause the overall length of the imaging lens to increase. Moreover, the radius of curvature of the fifth lens becomes excessively small, which may lead to excessive correction of coma and astigmatism. When G45L1SF is −1.20 or more, the radius of curvature of the fourth lens becomes excessively small, and correction of spherical aberration and coma may be insufficient. Moreover, the radius of curvature of the fifth lens becomes excessively large, which may lead to insufficient correction of coma and astigmatism.

From the viewpoint of axial downsizing of the imaging lens and favorable correction of coma and astigmatism, it is more preferable that G45L1SF is −2.50 or more. Furthermore, from the viewpoint of favorable correction of spherical aberration and coma, it is more preferable that G45L1SF is −1.40 or less, and even more preferable that G45L1SF is −1.50 or less.

$$< Formula ( 8 ) >$$

$$- 3. \leq f\_L1 / f \leq - 1. \qquad ( 8 )$$

here,
f_L1 is the focal length of the first lens, and
f is the focal length of the imaging lens.

Formula (8) relates to an appropriate ratio of the refractive power of the first lens to the refractive power of the imaging lens. It is preferable for the imaging lens to satisfy Formula (8) from the viewpoint of favorably correcting various aberrations of the imaging lens and the viewpoint of achieving a compact imaging lens with a large depth of field.

When f_L1/f is less than −3.00, the negative refractive power of the first lens becomes excessively weak, making it difficult to shorten the overall length of the imaging lens. When f_L1/f exceeds −1.00, the negative refractive power of the first lens becomes excessively strong, making coma and astigmatism more likely to occur and increase. Additionally, when f_L1/f exceeds −1.00, the radius of curvature of the image plane side lens surface of the first lens becomes excessively small, making the error sensitivity with respect to decentering of the first lens relative to the optical axis more likely to increase.

From the viewpoint of axial downsizing of the imaging lens, it is more preferable that f_L1/f is −2.50 or more, and even more preferable that f_L1/f is −1.74 or more. Furthermore, from the viewpoint of suppressing the occurrence of coma and astigmatism and the viewpoint of suppressing variations in optical characteristics due to variations in decentering sensitivity, it is more preferable that f_L1/f is −1.10 or less, and even more preferable that f_L1/f is −1.20 or less.

$$< Formula ( 9 ) >$$

$$- 0.4 \leq f\_L 1 / f\_L 2 \leq - 0.2 \qquad ( 9 )$$

here,
f_L1 is the focal length of the first lens, and
f_L2 is the focal length of the second lens.

Formula (9) relates to an appropriate ratio of the refractive power of the first lens to the refractive power of the second lens. It is preferable for the imaging lens to satisfy Formula (9) from the viewpoint of favorably correcting various aberrations and the viewpoint of downsizing the imaging lens.

When f_L1/f_L2 is less than −0.400, the refractive power of the first lens becomes excessively weak, which may increase the height of the ray incident on the first lens, and as a result, may lead to an increase in the diameter of the first lens. Furthermore, when f_L1/f_L2 is less than −0.400, the refractive power of the second lens becomes excessively strong, which may result in insufficient performance with respect to decentering, making it difficult to ensure the desired optical characteristics of the imaging lens. When f_L1/f_L2 exceeds −0.200, the refractive power of the first lens becomes excessively strong, which moves the position of the focal point formed by the first lens toward the image plane side. As a result, the overall length of the imaging device may be increased. Additionally, when f_L1/f_L2 exceeds −0.200, a Petzval sum may increase, which may lead to excessive correction of field curvature.

From the viewpoints of radial downsizing of the imaging lens and ensuring optical characteristics, it is more preferable that f_L1/f_L2 is −0.350 or more, and even more preferable that f_L1/f_L2 is −0.300 or more. Further, from the viewpoints of axial downsizing of the imaging lens and favorable correction of field curvature, it is more preferable that f_L1/f_L2 is −0.205 or less.

$$< Formula ( 10 ) >$$

$$1. < G 1 L 1 SF < 3. \qquad ( 10 )$$

Formula (10) relates to the shape (shaping factor) of the first lens. In Formula (10), “G1L1SF” is expressed by the following Formula (10-1).

G1L1SF=(G1L1Lr+G1L1Rr)/(G1L1Lr−G1L1Rr) (10-1)

In Formula (10-1), “G1L1Lr” represents the radius of curvature of the object side lens surface of the first lens, and “G1L1Rr” represents the radius of curvature of the image plane side lens surface of the first lens. It is preferable for the imaging lens to satisfy Formula (10) from the viewpoint of favorably correcting astigmatic chromatic aberration and distortion aberration.

When G1L1SF is 1.00 or less, the radius of curvature of the first lens becomes excessively large, resulting in insufficient refractive power of the first lens, which may cause the overall length of the imaging lens to increase. When G1L1SF is 3.00 or more, the radius of curvature of the first lens becomes excessively small, which may lead to insufficient correction of astigmatism and distortion aberration.

From the viewpoint of favorable correction of astigmatism and distortion aberration, it is more preferable that G1L1SF is 2.70 or less, and even more preferable that G1L1SF is 2.10 or less.

$$< Formula ( 11 ) >$$

$$0.5 \leq D 23 / BF \leq 1. \qquad ( 11 )$$

here,
D23 is the on-axis surface-to-surface distance between the second lens and the third lens, and
BF is the back focus of the imaging lens.

Formula (11) relates to the ratio of the on-axis surface-to-surface distance between the second lens and the third lens to the back focus of the imaging lens. The term “back focus” refers to the air-converted distance from the image plane side lens surface of the fifth lens to a paraxial image plane. D23 is also an air-converted length.

When D23/BF exceeds 1.000, the gap between the second lens and the third lens becomes excessively large, which may cause the overall length of the imaging lens to increase. Furthermore, the height of the ray incident on the third lens becomes large, and thus, it may be difficult to correct spherical aberration. When D23/BF is less than 0.500, the back focus becomes excessively large, which may cause the overall length of the imaging lens to increase.

From the viewpoints of axial downsizing of the imaging lens and favorable correction of spherical aberration, it is more preferable that D23/BF is 0.900 or less, and even more preferable that D23/BF is 0.850 or less. Also, from the viewpoint of axial downsizing of the imaging lens, it is more preferable that D23/BF is 0.600 or more, and even more preferable that D23/BF is 0.700 or more.

### [Imaging Device]

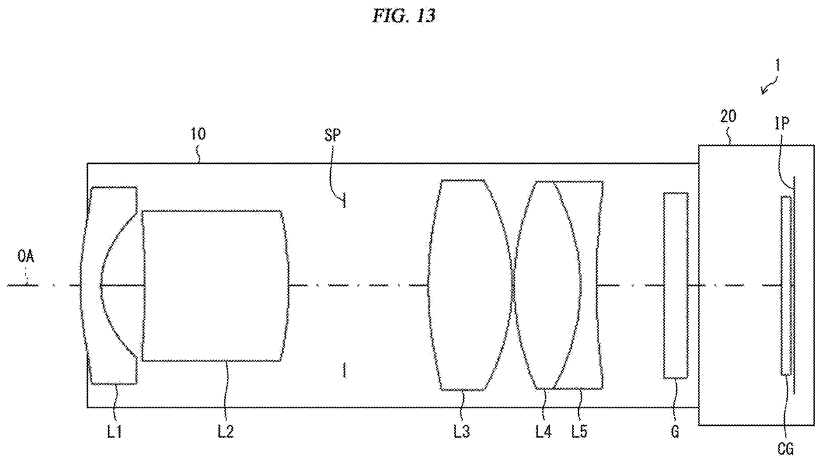

An imaging device according to one embodiment of the present invention includes the above-described optical system according to the present embodiment. A schematic configuration of the imaging device according to the present embodiment is illustrated in FIG. 13. As illustrated in FIG. 13, an imaging device 1 includes a main body 20 and a lens barrel 10. The imaging device 1 is, for example, an in-vehicle imaging device.

The main body 20 includes an imaging element and a cover glass CG. The imaging element is a photoelectric conversion element that converts an optical image into an electrical signal and is, for example, a solid-state imaging element. Examples of the solid-state imaging element include a charge coupled device (CCD) sensor and a complementary metal oxide semiconductor (CMOS) sensor. Note that a reference symbol IP denotes the surface (image plane) of the imaging element.

The lens barrel 10 is detachably attached to the main body 20 and internally includes a first lens L1, a second lens L2, a third lens L3, and a cemented lens composed of a fourth lens L4 and a fifth lens L5 on an optical axis QA in this order. The lenses from the first lens L1 to the fifth lens L5 constitute the imaging lens of the present embodiment described above. The optical axis OA is a common optical axis shared by the lenses of the lens barrel 10 and the imaging element of the main body 20.

In the imaging device 1, light incident from the object side through the imaging lens of the present embodiment is eventually focused onto the imaging surface of the imaging element. This imaging element performs photoelectric conversion of the received light and outputs the converted light as an electrical signal, thereby generating a digital image corresponding to the image of the subject. The digital image may be recorded onto a recording medium such as a hard disk device (HDD), memory card, optical disc, or magnetic tape. Note that when the imaging device 1 is a silver halide film camera, the image plane IP corresponds to the film surface.

The imaging device 1 includes the imaging lens of the present embodiment described above, which is compact, bright, and has stable optical performance, and therefore exhibits the same effects. Accordingly, the imaging device 1 is applicable to fixed-installation imaging devices such as surveillance imaging devices and in-vehicle imaging devices.

### SUMMARY

According to a first aspect of the present invention, an imaging lens includes, in order from an object side toward an image plane side: a first lens (L1) having negative refractive power; a second lens (L2) having positive refractive power and a meniscus shape; an aperture stop (SP); a third lens (L3) having positive refractive power; and a cemented lens composed of a fourth lens (L4) having positive refractive power and a fifth lens (L5) having negative refractive power, the cemented lens having positive combined refractive power, the imaging lens satisfying Formula (1) described above. According to the first aspect, it is possible to achieve an imaging lens which is compact, bright, and has stable optical performance.

According to a second aspect of the present invention, in the imaging lens of the first aspect, Formula (2) described above is satisfied. The second aspect is more effective from the viewpoint of favorable correction of aberrations.

According to a third aspect of the present invention, in the imaging lens of the first aspect or the second aspect, Formula (3) described above is satisfied. The third aspect is more effective from the viewpoint of suppressing variations in optical characteristics due to variations in decentering sensitivity and the viewpoint of suppressing the occurrence of aberrations.

According to a fourth aspect of the present invention, in the imaging lens of any one of the first to third aspects, Formula (4) described above is satisfied. The fourth aspect is more effective from the viewpoint of suppressing the occurrence of aberrations and the viewpoint of axial downsizing of the imaging lens.

According to a fifth aspect of the present invention, in the imaging lens of any one of the first to fourth aspects, Formula (5) described above is satisfied. The fifth aspect is more effective from the viewpoint of suppressing tilting of the image plane.

According to a sixth aspect of the present invention, in the imaging lens of any one of the first to fifth aspects, Formula (6) described above is satisfied. The sixth aspect is more effective from the viewpoint of favorable correction of aberrations, the viewpoint of axial downsizing of the imaging lens, and the viewpoint of favorable correction of spherical aberration.

According to a seventh aspect of the present invention, in the imaging lens of any one of the first to sixth aspects, Formula (7) described above is satisfied. The seventh aspect is more effective from the viewpoints of axial downsizing of the imaging lens and favorable correction of coma and astigmatism.

According to an eighth aspect of the present invention, in the imaging lens of any one of the first to seventh aspects, Formula (8) described above is satisfied. The eighth aspect is more effective from the viewpoint of axial downsizing of the imaging lens, the viewpoint of suppressing coma and astigmatism, and the viewpoint of suppressing variations in optical characteristics due to variations in decentering sensitivity.

According to a ninth aspect of the present invention, in the imaging lens of any one of the first to eighth aspects, Formula (9) described above is satisfied. The ninth aspect is more effective from the viewpoint of radial downsizing of the imaging lens, the viewpoint of ensuring optical characteristics, and the viewpoint of favorable correction of field curvature.

According to a tenth aspect of the present invention, in the imaging lens of any one of the first to ninth aspects, Formula (10) described above is satisfied. The tenth aspect is more effective from the viewpoint of favorable correction of astigmatism and distortion aberration.

According to an eleventh aspect of the present invention, an imaging device (1) includes the imaging lens according to any one of the first to tenth aspects, and an imaging element that is disposed on an image plane side of the imaging lens and converts an optical image formed by the imaging lens into an electrical signal. According to the eleventh aspect, it is possible to provide an imaging device which is compact, bright, and has stable optical performance.

As is apparent from the above description, the imaging lens according to the present invention enables cost reduction and downsizing with a reduced number of lenses, and allows high-resolution imaging. Further, since the imaging device according to the present invention includes the above-described imaging lens, downsizing is achieved while allowing high-resolution imaging.

Thus, the present invention can provide an imaging lens which achieves downsizing of the entire imaging lens, particularly reducing the diameter of the lens positioned closest to the object side and the overall length of the imaging lens, while being bright with an F-number of approximately 1.6 and exhibiting favorable imaging performance with reduced sensitivity to decentering.

The imaging lens and imaging device of the present invention are particularly suitable for use in, for example, surveillance cameras, security cameras, or in-vehicle cameras installed indoors or outdoors.

The imaging lens according to the present invention is compact, bright, and has stable optical performance. The present invention, which achieves such effects, is expected to contribute, for example, to the achievement of Sustainable Development Goal (SDG) 9 proposed by the United Nations, namely “build resilient infrastructure, promote sustainable industrialization and foster innovation”.

The present invention is not limited to the embodiments described above and can be modified in various ways within the scope of the claims. Embodiments obtained by appropriately combining the technical means respectively disclosed in different embodiments are also included in the technical scope of the present invention.

### EXAMPLES

One example of the present invention will be described below.

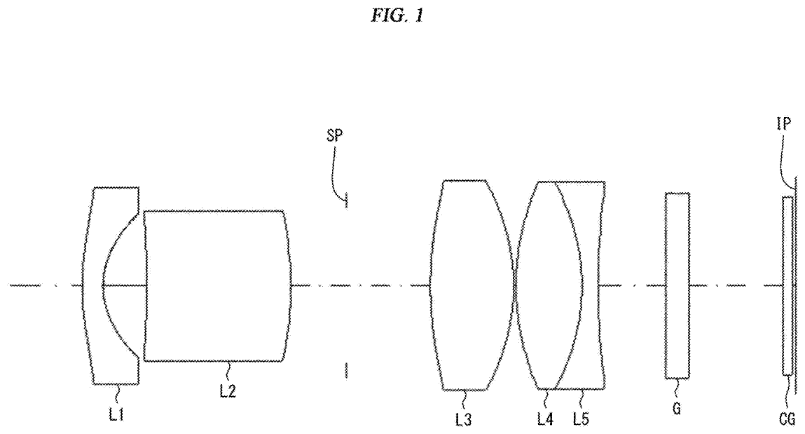

The lens configurations of the imaging lenses in the examples of the present invention are illustrated in FIGS. 1, 3, 5, 7, 9, and 11. The imaging lens of each example of the present invention includes, in order from the object side to the image plane side, the first lens L1, the second lens L2, the third lens L3, the fourth lens L4, and the fifth lens L5. The fourth lens L4 and the fifth lens L5 constitute the cemented lens. The optical aperture stop SP is disposed between the second lens L2 and the third lens L3. The aperture stop SP limits the diameter of the light flux (light amount) incident from the object side toward the image plane IP side. An optical block G is disposed between the fifth lens L5 and the image plane IP. The optical block G corresponds to an optical filter, a faceplate, a quartz low-pass filter, or an infrared cut filter, for example. In an imaging device including the imaging lens and a solid-state imaging element, the image plane IP corresponds to the imaging surface of the solid-state imaging element. As the solid-state imaging element, a photoelectric conversion element such as a charge coupled device (CCD) sensor or a complementary metal oxide semiconductor (CMOS) sensor can be used, for example.

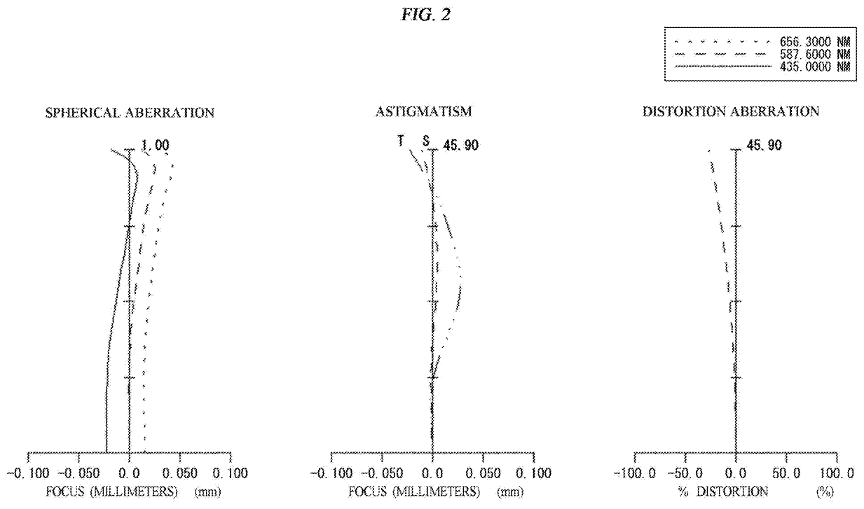

Longitudinal aberration diagrams of the imaging lenses of the examples of the present invention are illustrated in FIGS. 2, 4, 6, 8, 10, and 12. In each example, the longitudinal aberration diagrams, in order from the left side of the page, illustrate spherical aberration (SA [mm]), astigmatism (AST [mm]), and distortion aberration (DIS [%]). In the spherical aberration diagram, the vertical axis represents F-number (Fno), the dashed line indicates spherical aberration at a d-line (wavelength: 587.56 nm), the dotted line indicates spherical aberration at a C-line (wavelength: 656.27 nm), and the solid line indicates spherical aberration at a g-line (wavelength: 435.84 nm), respectively. In the astigmatism diagram, the vertical axis represents image height (Y), the dashed line indicates astigmatism of a sagittal ray ΔS at the d-line (wavelength 587.56 nm), and the chain double-dashed line indicates astigmatism of a meridional ray ΔT, respectively. In the distortion diagram, the vertical axis represents image height (Y), and the dashed line indicates distortion aberration at the d-line (wavelength 587.56 nm).

Surface data of all the lenses in the imaging lenses of the examples of the present invention are illustrated in Tables 1, 4, 7, 10, 13, and 16. In these tables, the “surface number” indicates the numbers of the lens surfaces of the lenses constituting the imaging lens, starting from the lens surface of the lens positioned closest to the object side as the first surface, and increasing sequentially toward the image plane side. The “R” in these tables indicates the radius of curvature [mm] of the lens surface corresponding to each surface number. However, when the value of R is indicated as INF, it indicates that the surface is flat. The “D” in these tables indicates an axial gap [mm] between a lens surface with a surface number i (where i is a natural number) and another lens surface with a surface number i+1. The “Nd” in these tables indicates the refractive index of each lens at the d-line (wavelength: 587.56 nm). The “ABV” in these tables indicates the Abbe number of each lens with respect to the d-line (wavelength: 587.56 nm).

Surface data of the aspheric lenses in the imaging lenses of the examples of the present invention are illustrated in Tables 2, 5, 8, 11, 14, and 17. These tables indicate the surface numbers of the aspheric lenses and the aspheric coefficients of the aspheric lenses. Note that the aspherical shape can be expressed by the following aspherical formula, where z is the displacement in the optical axis direction at a position located at a distance h from the optical axis, with the vertex of the surface as the reference:

$$z = {ch}^{2} / [ 1 + {\{ 1 - ( 1 + k ) {c}^{2} {h}^{2} \}}^{1 / 2} ] + A 4 {h}^{4} + A 6 {h}^{6} + A 8 {h}^{8} + A 10 {h}^{10} …$$

here,
c is the curvature (1/r),
h is the height from the optical axis,
k is the conic constant, and
A4, A6, A8, A10, . . . are the aspheric coefficients of each order.

It should be noted that in the numerical values of the aspheric coefficients and conic constants, the notation “E±m” (where m is an integer) represents “×10^{±m}”.

The specifications of the imaging lenses in the examples of the present invention are illustrated in Tables 3, 6, 9, 12, 15, and 18. These tables indicate the focal length [mm], F-number, half angle of view (θ) [deg], image height [mm], total lens length [mm], and back focus (BF) of the entire imaging lens system. The “total lens length” refers to the sum of the distance from the object side surface of the first lens to the image plane side surface of the fifth lens of the imaging lens and the back focus (BF) of the imaging lens. The back focus (BF) is a value obtained by air-converting the distance from the image plane side surface of the fifth lens to the paraxial image plane.

### Example 1

The lens configuration of the imaging lens in Example 1 is illustrated in FIG. 1. The longitudinal aberration of the imaging lens in Example 1 is illustrated in FIG. 2. The surface data, aspheric data, and specification table of the imaging lens in Example 1 are illustrated in Tables 1 to 3, respectively.

TABLE 1

| No. | | R | D | Nd | ABV |
|---|---|---|---|---|---|
| 1 | ASPH | 10.0503 | 0.9000 | 1.85134 | 40.10 |
| 2 | ASPH | 3.2892 | 1.8906 | | |
| 3 | | −35.506 | 6.1983 | 1.80808 | 22.76 |
| 4 | | −15.1251 | 2.4231 | | |
| 5 | STOP | INF | 3.6027 | | |
| 6 | ASPH | 16.1462 | 3.5902 | 1.61880 | 63.85 |
| 7 | ASPH | −8.4858 | 0.1044 | | |
| 8 | | 10.8218 | 2.8335 | 1.60300 | 65.46 |
| 9 | | −9.1000 | 0.7000 | 1.85450 | 25.15 |
| 10 | | 31.2674 | 2.9239 | | |
| 11 | | INF | 1.0000 | 1.51680 | 64.20 |
| 12 | | INF | 4.0750 | | |
| 13 | | INF | 0.4000 | 1.51680 | 64.20 |
| 14 | | INF | 0.1250 | | |

TABLE 2

| No. | K | *4 | *6 | *8 |
|---|---|---|---|---|
| 1 | 1.3497E+00 | −2.3113E−03 | 9.4399E−05 | −6.5235E−06 |
| 2 | −2.1563E+00 | 3.6998E−03 | 3.3167E−05 | −2.9930E−05 |
| 6 | −1.4414E+00 | 4.9821E−05 | −1.2638E−05 | 1.0875E−06 |
| 7 | 1.7865E−01 | 3.4206E−04 | −7.4704E−06 | 7.5017E−07 |

| No. | *10 | *12 |
|---|---|---|
| 1 | 3.4731E−07 | −8.3167E−09 |
| 2 | 4.0519E−06 | −1.6910E−07 |
| 6 | −6.2593E−08 | 9.4360E−10 |
| 7 | −3.9991E−08 | 5.2507E−10 |

TABLE 3

| | |
|---|---|
| Focal length [mm] | 4.55 |
| F-number | 1.56 |
| Half angle of view [°] | 45.9 |
| Image height [mm] | 3.46 |
| Total lens length [mm] | 30.77 |
| BF (in air) [mm] | 8.05 |

### Example 2

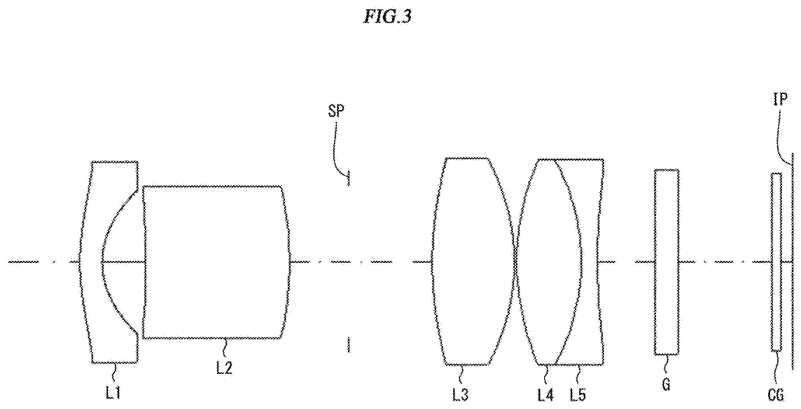

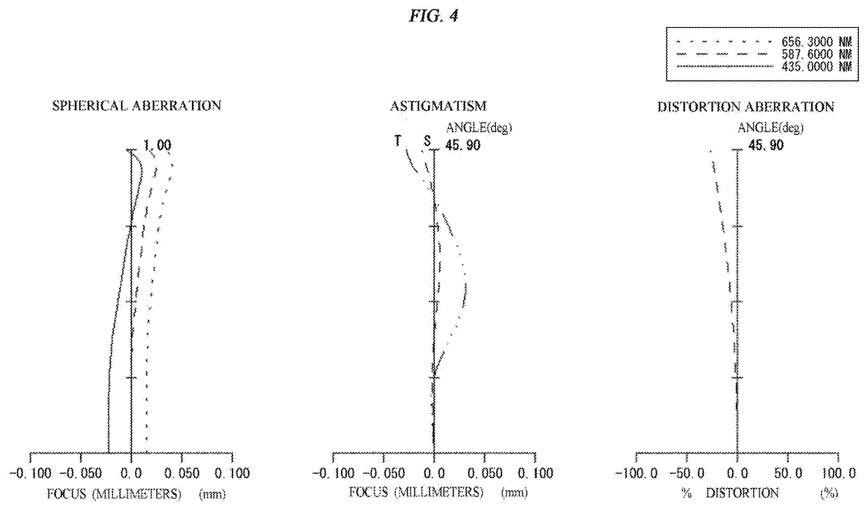

The lens configuration of the imaging lens in Example 2 is illustrated in FIG. 3. The longitudinal aberration of the imaging lens in Example 2 is illustrated in FIG. 4. The surface data, aspheric data, and specification table of the imaging lens in Example 2 are illustrated in Tables 4 to 6, respectively.

TABLE 4

| No. | | R | D | Nd | ABV |
|---|---|---|---|---|---|
| 1 | ASPH | 9.372 | 0.9599 | 1.85134 | 40.10 |
| 2 | ASPH | 3.2377 | 1.8932 | | |
| 3 | | −33.3111 | 6.2267 | 1.80808 | 22.76 |
| 4 | | −15.0193 | 2.5550 | | |
| 5 | STOP | INF | 3.6365 | | |
| 6 | ASPH | 15.7293 | 3.5500 | 1.61880 | 63.85 |
| 7 | ASPH | −8.6262 | 0.1000 | | |
| 8 | | 10.9732 | 2.8029 | 1.61800 | 63.40 |
| 9 | | −9.1000 | 0.7000 | 1.85450 | 25.15 |
| 10 | | 29.3032 | 2.4741 | | |
| 11 | | INF | 1.0000 | 1.51680 | 64.20 |
| 12 | | INF | 4.0750 | | |
| 13 | | INF | 0.4000 | 1.51680 | 64.20 |
| 14 | | INF | 0.5250 | | |

TABLE 5

| No. | K | *4 | *6 | *8 |
|---|---|---|---|---|
| 1 | 8.9330E−01 | −2.3822E−03 | 9.4784E−05 | −6.5528E−06 |
| 2 | −2.1775E+00 | 3.7395E−03 | 4.6605E−05 | −3.6803E−05 |
| 6 | −1.3374E+00 | 5.8460E−05 | −1.2322E−05 | 1.0733E−06 |
| 7 | 2.0517E−01 | 3.5982E−04 | −8.5966E−06 | 8.4878E−07 |

| No. | *10 | *12 |
|---|---|---|
| 1 | 83.5705E−07 | −8.7101E−09 |
| 2 | 4.9424E−06 | −2.1056E−07 |
| 6 | −5.9411E−08 | 9.2443E−10 |
| 7 | −4.2185E−08 | 5.7222E−10 |

TABLE 6

| | |
|---|---|
| Focal length [mm] | 4.55 |
| F-number | 1.56 |
| Half angle of view [°] | 45.9 |
| Image height [mm] | 3.46 |
| Total lens length [mm] | 30.90 |
| BF (in air) [mm] | 8.00 |

### Example 3

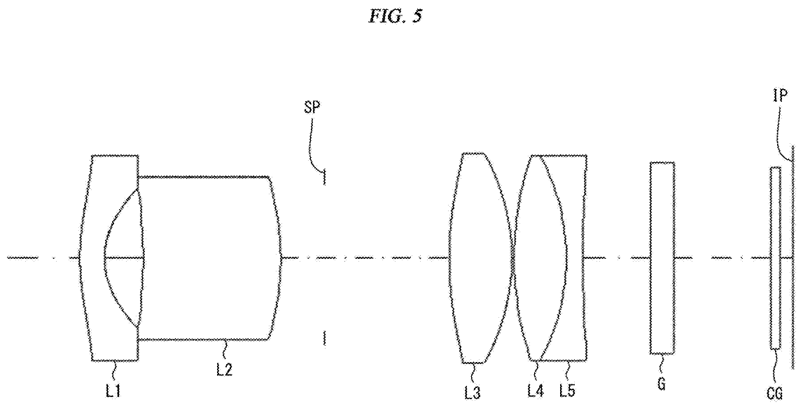

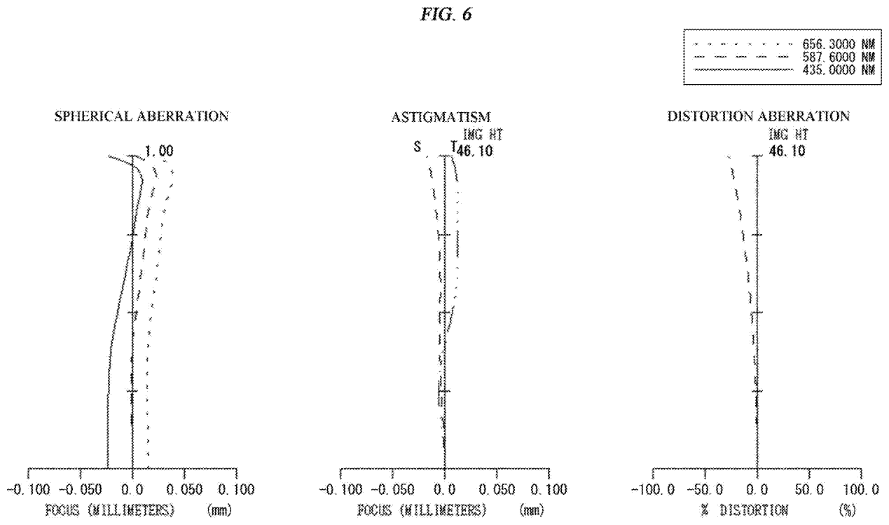

The lens configuration of the imaging lens in Example 3 is illustrated in FIG. 5. The longitudinal aberration of the imaging lens in Example 3 is illustrated in FIG. 6. The surface data, aspheric data, and specification table of the imaging lens in Example 3 are illustrated in Tables 7 to 9, respectively.

TABLE 7

| No. | | R | D | Nd | ABV |
|---|---|---|---|---|---|
| 1 | ASPH | 9.0770 | 1.0454 | 1.85134 | 40.10 |
| 2 | ASPH | 3.1322 | 1.6302 | | |
| 3 | | −20.3736 | 5.8082 | 1.85450 | 25.15 |
| 4 | | −11.4812 | 1.8389 | | |
| 5 | STOP | INF | 5.2634 | | |
| 6 | ASPH | 14.9711 | 2.6479 | 1.61880 | 63.85 |
| 7 | ASPH | −8.4333 | 0.1000 | | |
| 8 | | 13.5980 | 2.1966 | 1.60300 | 65.46 |
| 9 | | −9.0000 | 0.7000 | 1.85450 | 25.15 |
| 10 | | 52.6014 | 2.8507 | | |
| 11 | | INF | 1.0000 | 1.51680 | 64.20 |
| 12 | | INF | 4.0750 | | |
| 13 | | INF | 0.4000 | 1.51680 | 64.20 |
| 14 | | INF | 0.5250 | | |

TABLE 8

| No. | K | *4 | *6 | *8 |
|---|---|---|---|---|
| 1 | 6.1500E−01 | −2.4076E−03 | 8.2079E−05 | −6.6108E−06 |
| 2 | −2.1265E+00 | 4.0129E−03 | 4.2326E−05 | −4.1680E−05 |
| 6 | −1.3425E+00 | 5.8747E−05 | −1.6059E−05 | 1.1536E−06 |
| 7 | 1.3358E−01 | 3.9707E−04 | −1.2497E−05 | 9.3719E−07 |

| No. | *10 | *12 |
|---|---|---|
| 1 | 4.0662E−07 | −1.0412E−08 |
| 2 | 5.0174E−06 | −2.0168E−07 |
| 6 | −4.1273E−08 | −4.6812E−10 |
| 7 | −2.8973E−08 | −5.4993E−10 |

TABLE 9

| | |
|---|---|
| Focal length [mm] | 4.55 |
| F-number | 1.56 |
| Half angle of view [°] | 46.1 |
| Image height [mm] | 3.46 |
| Total lens length [mm] | 30.08 |
| BF (in air) [mm] | 8.37 |

### Example 4

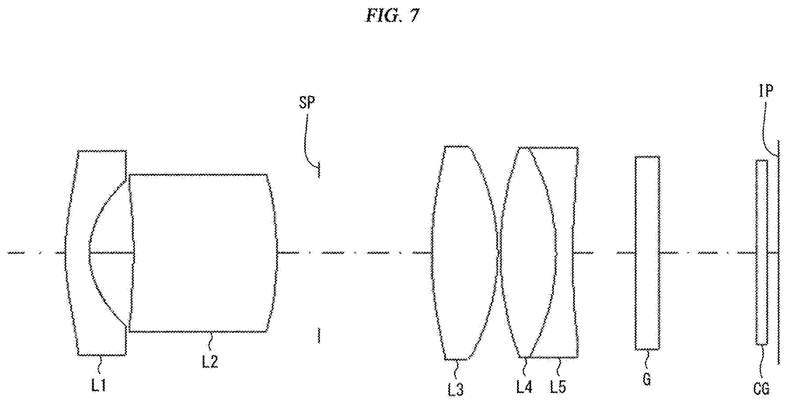

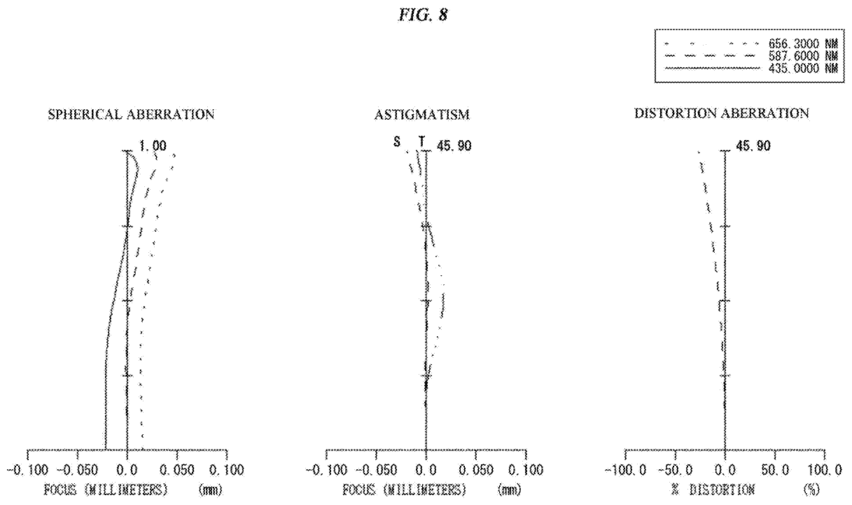

The lens configuration of the imaging lens in Example 4 is illustrated in FIG. 7. The longitudinal aberration of the imaging lens in Example 4 is illustrated in FIG. 8. The surface data, aspheric data, and specification table of the imaging lens in Example 4 are illustrated in Tables 10 to 12, respectively.

TABLE 10

| No. | | R | D | Nd | ABV |
|---|---|---|---|---|---|
| 1 | ASPH | 9.0633 | 1.0030 | 1.85134 | 40.10 |
| 2 | ASPH | 3.1269 | 1.8418 | | |
| 3 | | −25.6945 | 5.9900 | 1.85450 | 25.15 |
| 4 | | −12.4668 | 1.7489 | | |
| 5 | STOP | INF | 4.6939 | | |
| 6 | ASPH | 15.4202 | 2.7594 | 1.61880 | 63.85 |
| 7 | ASPH | −8.2813 | 0.1000 | | |
| 8 | | 12.1918 | 2.3266 | 1.60300 | 65.46 |
| 9 | | −9.0000 | 0.7000 | 1.85450 | 25.15 |
| 10 | | 36.8655 | 2.6120 | | |
| 11 | | INF | 1.0000 | 1.51680 | 64.20 |
| 12 | | INF | 4.0750 | | |
| 13 | | INF | 0.4000 | 1.51680 | 64.20 |
| 14 | | INF | 0.5250 | | |

TABLE 11

| No. | K | *4 | *6 | *8 |
|---|---|---|---|---|
| 1 | 7.3570E−01 | −2.3601E−03 | 8.2883E−05 | −6.7095E−06 |
| 2 | −2.0092E+00 | 3.9243E−03 | 3.9918E−05 | −3.9666E−05 |
| 6 | −1.1979E+00 | 6.3584E−05 | −1.6275E−05 | 1.1548E−06 |
| 7 | 1.1930E−01 | 3.9732E−04 | −1.1196E−05 | 9.0139E−07 |

| No. | *10 | *12 |
|---|---|---|
| 1 | 4.0268E−07 | −1.0006E−08 |
| 2 | 5.1323E−06 | −2.1196E−07 |
| 6 | −4.2281E−08 | −4.8373E−10 |
| 7 | −3.2383E−08 | −3.9298E−10 |

TABLE 12

| | |
|---|---|
| Focal length [mm] | 4.55 |
| F-number | 1.56 |
| Half angle of view [°] | 45.9 |
| Image height [mm] | 3.46 |
| Total lens length [mm] | 29.78 |
| BF (in air) [mm] | 8.14 |

### Example 5

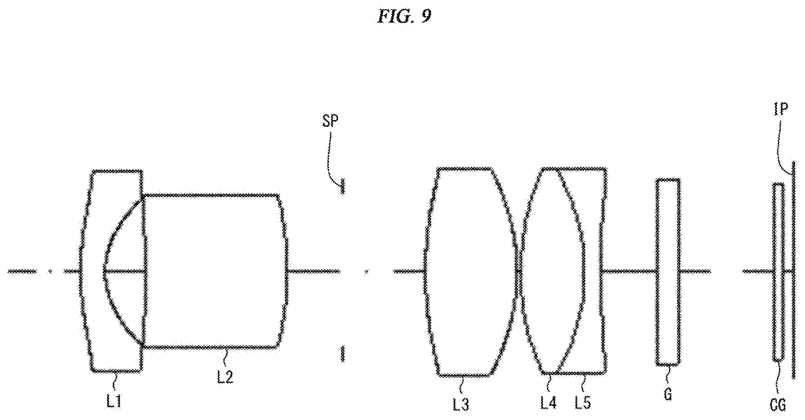

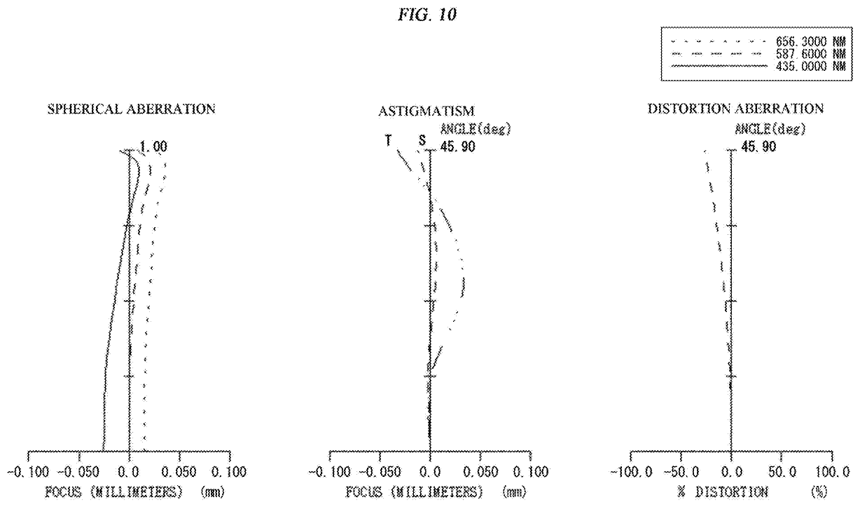

The lens configuration of the imaging lens in Example 5 is illustrated in FIG. 9. The longitudinal aberration of the imaging lens in Example 5 is illustrated in FIG. 10. The surface data, aspheric data, and specification table of the imaging lens in Example 5 are illustrated in Tables 13 to 15, respectively.

TABLE 13

| No. | | R | D | Nd | ABV |
|---|---|---|---|---|---|
| 1 | ASPH | 9.4406 | 1.0756 | 1.85134 | 40.10 |
| 2 | ASPH | 3.2141 | 1.7693 | | |
| 3 | | −30.5121 | 6.1386 | 1.80808 | 22.76 |
| 4 | | −14.6312 | 2.4693 | | |
| 5 | STOP | INF | 3.5557 | | |
| 6 | ASPH | 15.7812 | 3.9677 | 1.61880 | 63.85 |
| 7 | ASPH | −8.6535 | 0.1657 | | |
| 8 | | 10.9639 | 2.7713 | 1.61800 | 63.40 |
| 9 | | −8.8478 | 0.7000 | 1.85450 | 25.15 |
| 10 | | 34.2806 | 2.4247 | | |
| 11 | | INF | 1.0000 | 1.51680 | 64.20 |
| 12 | | INF | 4.0750 | | |
| 13 | | INF | 0.4000 | 1.51680 | 64.20 |
| 14 | | INF | 0.5250 | | |

TABLE 14

| No. | K | *4 | *6 | *8 |
|---|---|---|---|---|
| 1 | 8.4803E−01 | −2.3921E−03 | 9.5423E−05 | −6.6145E−06 |
| 2 | −2.1965E+00 | 3.7362E−03 | 4.6959E−05 | −3.7282E−05 |
| 6 | −1.2932E+00 | 6.0130E−05 | −1.2104E−05 | 1.0702E−06 |
| 7 | 2.3173E−01 | 3.5425E−04 | −8.8335E−06 | 8.5513E−07 |

| No. | *10 | *12 |
|---|---|---|
| 1 | 3.5973E−07 | −8.6756E−09 |
| 2 | 4.9598E−06 | −2.1078E−07 |
| 6 | −6.0352E−08 | 1.0350E−09 |
| 7 | −4.0164E−08 | 5.4213E−10 |

TABLE 15

| | |
|---|---|
| Focal length [mm] | 4.55 |
| F-number | 1.57 |
| Half angle of view [°] | 45.9 |
| Image height [mm] | 3.45 |
| Total lens length [mm] | 31.04 |
| BF (in air) [mm] | 8.14 |

### Example 6

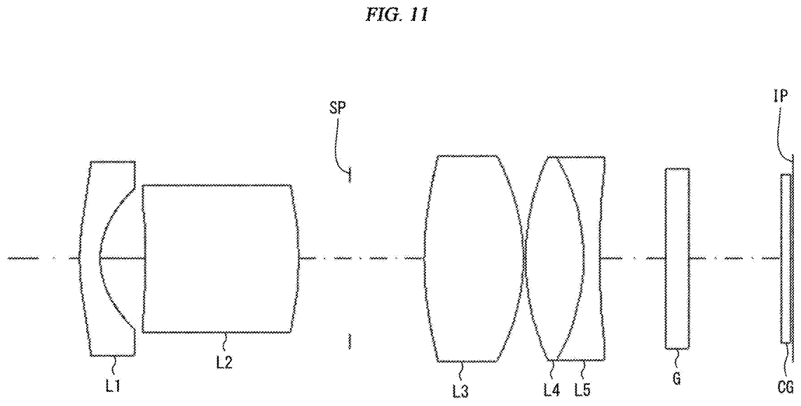

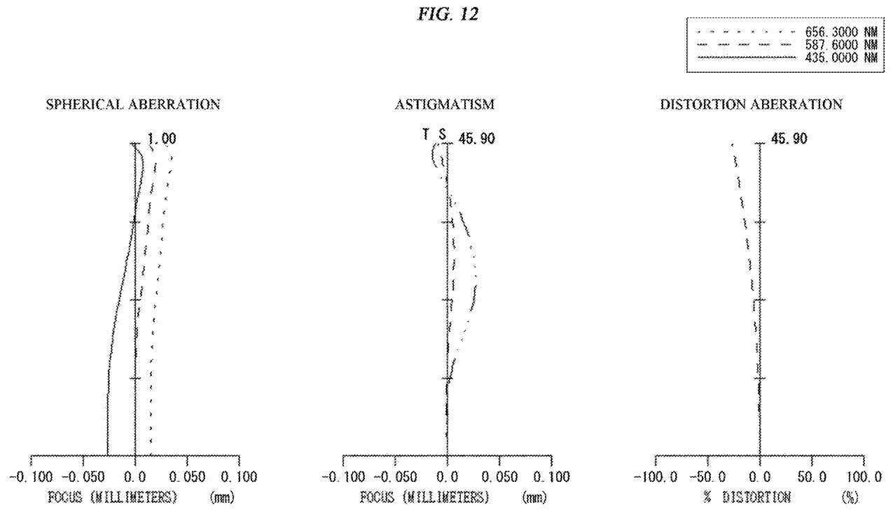

The lens configuration of the imaging lens in Example 6 is illustrated in FIG. 11. The longitudinal aberration of the imaging lens in Example 6 is illustrated in FIG. 12. The surface data, aspheric data, and specification table of the imaging lens in Example 6 are illustrated in Tables 16 to 18, respectively.

TABLE 16

| No. | | R | D | Nd | ABV |
|---|---|---|---|---|---|
| 1 | ASPH | 10.0845 | 0.9000 | 1.85134 | 40.10 |
| 2 | ASPH | 3.2769 | 1.9851 | | |
| 3 | | −30.0543 | 6.7427 | 1.80808 | 22.76 |
| 4 | | −14.4587 | 2.2439 | | |
| 5 | STOP | INF | 3.2937 | | |
| 6 | ASPH | 15.9250 | 4.3441 | 1.61880 | 63.85 |
| 7 | ASPH | −8.7149 | 0.1000 | | |
| 8 | | 10.4903 | 2.5518 | 1.60300 | 65.46 |
| 9 | | −9.1000 | 0.7000 | 1.85450 | 25.15 |
| 10 | | 32.8944 | 2.9234 | | |
| 11 | | INF | 1.0000 | 1.51680 | 64.20 |
| 12 | | INF | 4.0750 | | |
| 13 | | INF | 0.4000 | 1.51680 | 64.20 |
| 14 | | INF | 0.1250 | | |

TABLE 17

| No. | K | *4 | *6 | *8 |
|---|---|---|---|---|
| 1 | 1.2728E+00 | −2.3268E−03 | 9.3441E−05 | −6.3662E−06 |
| 2 | −2.0921E+00 | 3.5486E−03 | 3.1201E−05 | −2.7679E−05 |
| 6 | −1.2326E+00 | 5.5466E−05 | −1.2226E−05 | 1.0995E−06 |
| 7 | 2.1885E−01 | 3.2599E−04 | −7.5081E−06 | 7.5850E−07 |

| No. | *10 | *12 |
|---|---|---|
| 1 | 3.6605E−07 | −9.9815E−09 |
| 2 | 4.0779E−06 | −1.8992E−07 |
| 6 | −6.2793E−08 | 1.0823E−09 |
| 7 | −3.9103E−08 | 5.9504E−10 |

TABLE 18

| | |
|---|---|
| Focal length [mm] | 4.40 |
| F-number | 1.56 |
| Half angle of view [°] | 45.9 |
| Image height [mm] | 3.34 |
| Total lens length [mm] | 31.38 |
| BF (in air) [mm] | 7.95 |

The values calculated by the above formulae in Examples 1 to 6 are illustrated in Table 19.

TABLE 19

| Formula | | Example1 | Example2 | Example3 | Example4 | Example5 | Example6 |
|---|---|---|---|---|---|---|---|
| (1) | f_L45/f | 33.88 | 31.80 | 74.46 | 99.35 | 21.98 | 25.01 |
| (2) | f_L1/f_L45 | −0.0397 | −0.0433 | −0.0180 | −0.0134 | −0.0622 | −0.0552 |
| (3) | f_L3/f_L2 | 0.3316 | 0.3245 | 0.3851 | 0.3886 | 0.3246 | 0.3378 |
| (4) | f_L2/f | 6.309 | 6.457 | 5.201 | 5.153 | 6.519 | 6.569 |
| (5) | f_L1/f_L3 | −0.6426 | −0.6567 | −0.6708 | −0.6672 | −0.6457 | −0.6220 |
| (6) | f_L3/f_L45 | 0.0617 | 0.0659 | 0.0269 | 0.0202 | 0.0963 | 0.0887 |
| (7) | G45L1SF | −2.059 | −2.197 | −1.697 | −1.988 | −1.940 | −1.936 |
| (8) | f_L1/f | −1.345 | −1.376 | −1.343 | −1.336 | −1.367 | −1.380 |
| (9) | f_L1/f_L2 | −0.2131 | −0.2131 | −0.2583 | −0.2593 | −0.2096 | −0.2101 |
| (10) | G1L1SF | 1.973 | 2.056 | 2.054 | 2.053 | 2.032 | 1.963 |
| (11) | D23/BF | 0.749 | 0.774 | 0.849 | 0.791 | 0.740 | 0.697 |

1. An imaging lens comprising:
in order from an object side toward an image plane side:
a first lens having negative refractive power;
a second lens having positive refractive power and a meniscus shape;
an aperture stop;
a third lens having positive refractive power; and
a cemented lens composed of a fourth lens having positive refractive power and a fifth lens having negative refractive power, the cemented lens having positive combined refractive power,
the imaging lens satisfying a formula below:
$$20. \leq f\_L 45 / f \leq 110. \qquad ( 1 )$$
here,
f_L45 is the focal length of the cemented lens, and
f is the focal length of the imaging lens.

2. The imaging lens according to claim 1 satisfying a formula below:
$$- 0.12 \leq f\_L 1 / f\_L 45 \leq - 0.01 \qquad ( 2 )$$
here,
f_L1 is a focal length of the first lens.

3. The imaging lens according to claim 1 satisfying a formula below:
$$0.18 \leq f\_L 3 / f\_L 2 \leq 0.6 \qquad ( 3 )$$
here,
f_L2 is a focal length of the second lens, and
f_L3 is a focal length of the third lens.

4. The imaging lens according to claim 1 satisfying a formula below:
$$4. \leq f\_L 2 / f \leq 10. \qquad ( 4 )$$
here,
f_L2 is a focal length of the second lens.

5. The imaging lens according to claim 1 satisfying a formula below:
$$- 1. \leq f\_L 1 / f\_L 3 \leq - 0.3 \qquad ( 5 )$$
here,
f_L1 is a focal length of the first lens, and
f_L3 is a focal length of the third lens.

6. The imaging lens according to claim 1 satisfying a formula below:
$$0.01 \leq f\_L 3 / f\_L 45 \leq 0.15 \qquad ( 6 )$$
here,
f_L3 is a focal length of the third lens.

7. The imaging lens according to claim 1 satisfying a formula below:
$$- 3. < G 45 L 1 SF < - 1.2 \qquad ( 7 )$$
here,
G45L1SF is expressed by a formula below:
$$G 45 L 1 SF = ( G 4 L 1 Lr + G 5 L 1 Rr ) / ( G 4 L 1 Lr - G 5 L 1 Rr ) \qquad ( 7 - 1 )$$
here,
G4L1Lr is a radius of curvature of an object side lens surface of the fourth lens, and
G5L1Rr is a radius of curvature of an image plane side lens surface of the fifth lens.

8. The imaging lens according to claim 1 satisfying a formula below:
$$- 3. \leq f\_L 1 / f \leq - 1. \qquad ( 8 )$$
here,
f_L1 is a focal length of the first lens.

9. The imaging lens according to claim 1 satisfying a formula below:
$$- 0.4 \leq f\_L 1 / f\_L 2 \leq - 0.2 \qquad ( 9 )$$
here,
f_L1 is a focal length of the first lens, and
f_L2 is a focal length of the second lens.

10. The imaging lens according to claim 1, wherein
the first lens is a concave meniscus lens, and a formula below is satisfied:
$$1. < G 1 L 1 SF < 3. \qquad ( 10 )$$
here,
G1L1SF is expressed by a formula below:
$$G 1 L 1 SF = ( G 1 L 1 Lr + G 1 L 1 Rr ) / ( G 1 L 1 Lr - G 1 L 1 Rr ) \qquad ( 10 - 1 )$$
here,
G1L1Lr is a radius of curvature of an object side lens surface of the first lens, and
G1L1Rr is a radius of curvature of an image plane side lens surface of the first lens.

11. An imaging device comprising:
the imaging lens according to claim 1; and
an imaging element that is disposed on an image plane side of the imaging lens and converts an optical image formed by the imaging lens into an electrical signal.

12. An imaging device comprising:
the imaging lens according to claim 2; and
an imaging element that is disposed on an image plane side of the imaging lens and converts an optical image formed by the imaging lens into an electrical signal.

13. An imaging device comprising:
the imaging lens according to claim 3; and
an imaging element that is disposed on an image plane side of the imaging lens and converts an optical image formed by the imaging lens into an electrical signal.

14. An imaging device comprising:
the imaging lens according to claim 4; and
an imaging element that is disposed on an image plane side of the imaging lens and converts an optical image formed by the imaging lens into an electrical signal.

15. An imaging device comprising:
the imaging lens according to claim 5; and
an imaging element that is disposed on an image plane side of the imaging lens and converts an optical image formed by the imaging lens into an electrical signal.

16. An imaging device comprising:
the imaging lens according to claim 6; and
an imaging element that is disposed on an image plane side of the imaging lens and converts an optical image formed by the imaging lens into an electrical signal.

17. An imaging device comprising:
the imaging lens according to claim 7; and
an imaging element that is disposed on an image plane side of the imaging lens and converts an optical image formed by the imaging lens into an electrical signal.

18. An imaging device comprising:
the imaging lens according to claim 8; and
an imaging element that is disposed on an image plane side of the imaging lens and converts an optical image formed by the imaging lens into an electrical signal.

19. An imaging device comprising:
the imaging lens according to claim 9; and
an imaging element that is disposed on an image plane side of the imaging lens and converts an optical image formed by the imaging lens into an electrical signal.

20. An imaging device comprising:
the imaging lens according to claim 10; and
an imaging element that is disposed on an image plane side of the imaging lens and converts an optical image formed by the imaging lens into an electrical signal.
